(19) United States
(12) Patent Application Publication
(10) Pub. No.: US 2008/0124498 A1
(43) Pub. Date: May 29, 2008

(54) Laser marking of pigmented substrates

(76) Inventors: Damien Thurber Cole, Drexel Hill, PA (US); Joseph E. Sarver, Erial, NJ (US); Colin Dennis Campbell, Claymont, DE (US)

Correspondence Address: JoAnn Villamizar;Ciba Corporation/Patent Department, 540 White Plains Road, P.O. Box 2005, Tarrytown, NY, 10591, US

(21) Appl. No.: 11/978,764

(22) Filed: Oct. 30, 2007

Related U.S. Application Data
(60) Provisional application No. 60/857,245, filed on Nov. 7, 2006.

(51) Int. Cl. C09K 11/06; C08F 6/00; B41M 5/24; B44F 1/10

(52) U.S. Cl. 428/29; 252/301.35; 522/2; 503/201

(57) ABSTRACT

A method for producing fluorescent markings on a substrate which method comprises exposing a composition comprising a polymer and an organic pigment to a heat source, such as laser radiation, to produce a fluorescent markings which are not discernable when viewed under ambient visible light but readily apparent under UV light is disclosed. The method produces novel compositions wherein a fluorescent form of a pigment is present at a higher concentration in defined domains relative to the remainder of the composition. The novel polymer composition is particularly useful in security marking applications.

This application claims benefit under 35 USC 119(e) of U.S. provisional application No. 60/857,245, filed Nov. 7, 2006

A method for laser marking a substrate is provided, which method comprises exposing a composition comprising a polymer and an organic pigment, e.g., quinacridone, diketopyrrolopyrrole (DPP) or perylene pigment etc, to a heat source, such as laser radiation, to produce a fluorescent marking readily apparent under UV light. The marking is not discernable when viewed under ambient visible light. Exposure to the heat source changes at least a portion of the pigment from a non-fluorescent colorant to a fluorescent colorant without changing the color of the substrate when viewed under ambient light. A novel composition is thus provided wherein a fluorescent form of a pigment is present at a higher concentration in defined domains relative to the remainder of the composition which is particularly useful in security marking applications.

### BACKGROUND OF THE INVENTION

Laser marking is a well known and important means for quickly and cleanly inscribing plastic surfaces with identifying, functional or decorative markings, such as date codes, batch codes, bar codes, part numbers, computer keyboard characters and company logos. The most common laser marks are either a dark mark on a lighter colored background or a light mark on a dark colored background. Colored laser markings on plastic articles are also known.

It is known that many pigments can be altered by exposure to the heat generated by laser radiation. U.S. Pat. No. 4,861,620, incorporated herein in its entirety by reference, discloses pigments that undergo a color change when exposed to laser radiation due to an irreversible or semi-irreversible change of internal structure. Some pigments thermally decompose upon heating and change color due to chemical reactions that change the molecular structure; other pigments undergo a change of crystalline structure which changes their color.

U.S. Pat. No. 6,022,905, incorporated herein in its entirety by reference, discloses a laser-marked plastic article comprising at least two differently colored laser marks produced by exposing to various laser energies a thermoplastic composition comprising a laser energy absorbing additive and color pigments capable of chemically and irreversibly changing the original color to a second color at higher than a predetermined temperature.

There are innumerable different types of documents and articles which are subject to counterfeiting or forgery, and many different techniques and devices have been developed for determining the authenticity of a document or a thing. By way of example only, documents which are particularly in need of authentication include bank notes, identification papers, passports, packaging, labels and stickers, driver's licenses, admission tickets and other tickets, tax stamps, pawn stamps, and stock certificates.

U.S. Pat. No. 6,335,783, incorporated herein in its entirety by reference, discloses soluble pigment precursors useful in security marking applications due to their thermo chromic properties which generate different colored species when heated.

It is known to provide secured documents such as bank notes with an authentication element in the form of a distinctive luminescent ink which, when excited by a light of a predetermined wavelength, will emit a distinctive low intensity radiation that can be detected and analyzed as a means for authenticating a secured document. German Patent DE 411 7911 A1 discloses such a system which includes a conically expanding fiber optical waveguide and an optical processing system.

U.S. Pat. Nos. 6,054,021 and 6,174,586, incorporated herein in their entirety by reference, disclose the use of fluorescent whitening agents in security paper to create a pattern that is invisible under ambient light, i.e., visible light as found in interior lighting or sunlight, but becomes visible under ultraviolet light due to fluorescence of the fluorescent whitening agent.

U.S. Pat. No. 5,075,195, incorporated herein in its entirety by reference, discloses a method of laser marking a plastics object wherein the object to be marked contains a radiation-sensitive additive, e.g., molybdenum disulfide, which effects a change in light reflectance to form a visible effect mark on said object whose contrast undergoes visual change depending on the angle of light impinging thereon and on the angle with which it is visible.

U.S. Pat. No. 6,372,394, incorporated herein in its entirety by reference, relates to a method of marking articles by a laser and more particularly to a method of marking security documents or other documents having a clear substrate covered by opacifying layers.

U.S. Pat. No. 5,879,855 discloses compositions containing pigment precursors. When exposed to, for example, heat, the pigment precursors are converted into pigments with visibly different color characteristics. Structured colored patterns can be prepared using these compositions by, for example, irradiating with a laser wherein the laser irradiation occurs over the desired pattern. These patterns are of a different color than the remainder of the composition and are clearly visible under ordinary viewing conditions.

Co pending U.S. application Ser. No. 11/589,530, incorporated herein in its entirety by reference, discloses tetrabenzodiazadiketoperylene pigments which, when incorporated into a polymer system and then exposed to heat or laser radiation, produce fluorescent marks that are readily apparent under ultraviolet light but are not readily apparent under ambient light. Such marks (or markings) which are visible only under certain specific conditions provide a unique opportunity in, for example, security marking and brand identification of printed packaging.

It has now been found that other pigments, already found in coating and other polymer applications, such as certain quinacridone, diketopyrrolopyrrole and perylene pigments, also produce fluorescent marks when exposed to laser marking conditions without changing the apparent color of the composition containing the pigments. The marks are therefore readily apparent under ultraviolet light but are not readily apparent under ambient light.

### SUMMARY OF THE INVENTION

Exposure of a portion of a polymer composition containing certain organic pigments to a heat source, for example laser radiation or diode array, coverts the pigments within the exposed portion of the composition from non-fluorescent species into fluorescent species without the exposed portions undergoing any apparent change in color when viewed under ambient visible light, i.e., natural outdoor lighting or typical indoor lighting as found in everyday life.

While not wishing to be bound by theory, it is believed that, for example, laser radiation raises the local temperature at the point of radiation contact with the pigmented polymer to increase high enough to cause the pigment to become somewhat solubilzed by the polymer matrix. The solubilzed portions of these pigments are fluorescent and are thus present in higher concentrations in the portions of the composition exposed to the laser radiation than in the non-exposed portions.

A polymeric substrate can thus be prepared which contains markings that are not visible under typical lighting conditions encountered in everyday life, but which markings are visible under certain wavelengths of ultraviolet light due to the presence of a higher concentration of the fluorescent form of the pigment in the marked areas. The marked areas of course will fluoresce only when irradiated by those wavelengths of ultraviolet light that are absorbed by the fluorescing species; likewise, the fluorescence emitted will be of specific wavelengths of visible light as determined by the chemistry of the colorant. One can therefore, by proper selection of pigment, choose the color of the fluorescence.

The exact amount of pigment which is converted to the fluorescent form will vary depending on pigment, polymeric substrate, exposure conditions, etc. In some instances, the conversion to fluorescent form will take place only at the surface of the composition, in other instances; conversion will also take place at deeper regions within the polymer. The amount of conversion necessary for the invention is the amount that produces a high enough concentration of the fluorescent form of the pigment so that the laser marked portions fluoresce more strongly under UV light than the remaining portion of the substrate without changing the color observed under ambient lighting.

### DETAILED DESCRIPTION OF THE INVENTION

Provided is a composition comprising a natural or synthetic polymer and a colorant, which colorant is present throughout the composition and which colorant is present in a fluorescent form and a non-fluorescent form, wherein
the non-fluorescent form of the colorant is a pigment selected from the group consisting of quinacridone, diketopyrrolopyrrole (DPP), perylene, indanthrone, anthroquinone, azo, isoindoline and phthalocyanine pigments and
the fluorescent form of the colorant is of the same chemical formula as the pigment and is obtained from the pigment by exposure of specific portions of the composition to heat to form defined domains,
wherein the fluorescent form of the pigment is present at a higher concentration in defined domains relative to the remainder of the composition to display an identifiable fluorescent marking when exposed to appropriate wavelengths of ultraviolet light
and wherein the defined domains containing a higher concentration of the fluorescent form of the colorant are of the same color as those parts of the composition which are not exposed to heat when viewed under a light source with a wavelength of from 400 to 700 nm or when measured with CIE L*A*B* color measuring equipment under exclusion of UV light.

The same color should be understood as a color difference ΔE* of ≦3, preferably ≦2 (CIE L*A*B* colour space). The total amount of colorant is suitably identical in the fluorescent and non-fluorescent domains of the composition.

The pigments used as colorants of the invention can also be a mixed crystal or solid solution comprising the above pigments. For example, the pigment is selected from a quinacridone, DPP or perylene pigment, or a mixed crystal or solid solution thereof. The polymer of the polymer composition is, for example, a thermoplastic, thermoset, crosslinked or inherently crosslinked polymer. The polymer may be, for example, in the form of a film, sheet, molded article, extruded workpiece, fiber, laiminate, felt or woven fabric or part of a coating composition.

In one particular embodiment, the polymer composition is a coating or film, for example a coating or film adhered to the surface of an organic or inorganic substrate.

Also provided is a method for producing a polymer composition bearing fluorescent markings, which method comprises incorporating into a natural or synthetic polymer a non-fluorescent form of a colorant selected from quinacridone, diketopyrrolopyrrole, perylene indanthrone, anthroquinone, azo, isoindoline and phthalocyanine pigments, including mixed crystals and solid solutions, for example, the colorant is selected from a quinacridone, DPP or perylene pigment,

and then exposing specific domains of the polymer composition to heat, for example a diode array or laser irradiation, to convert portions of the pigment into a fluorescent form of the colorant producing markings which fluoresce when exposed to appropriate wavelengths of ultra violet light

wherein the specific domains which are exposed to heat to produce the fluorescent markings remain the same color as those parts of the composition which are not exposed to heat when viewed under a light source with a wavelength of from 400 to 700 nm or when measured with CIE L*A*B* color measuring equipment under exclusion of UV light.

For example, a red coating containing a quinacridone, diketopyrrolopyrrole or perylene pigment is marked using commercially available laser technology a laser as a source of heat and no change is visible under ambient light, i.e. the entire coating remains the same color of red. However, the markings fluoresce in a different bright color, e.g., yellow, under a black light source (i.e., an ultra violet light source).

For example, the composition displays a uniform color (ΔE*≦3, preferably ΔE*≦2) when viewed under a light source dominated by wavelengths in the range from 400 to 700 nm, such as ambient visible light, or when measured with a CIE L*A*B* color measuring equipment under exclusion of UV light.

In one particular embodiment, the polymer composition of the above method is a coating or film.

Also provided is a method for producing a laser marked substrate, which method comprises applying to a substrate a coating or film comprising a polymer and a non-fluorescent form of a colorant selected from quinacridone, diketopyrrolopyrrole, perylene indanthrone, anthroquinone, azo, isoindoline and phthalocyanine pigments, including mixed crystals and solid solutions, for example, the colorant is selected from a quinacridone, DPP or perylene pigment,

and then exposing specific domains of the coating or film to heat, for example a diode array or laser irradiation, to convert portions of the pigment into a fluorescent form of the colorant producing markings which fluoresce when exposed to appropriate wavelengths of ultra violet light

wherein the specific domains which are exposed to heat to produce the fluorescent markings remain the same color as those parts of the composition which are not exposed to heat when viewed under a light source with a wavelength of from 400 to 700 nm or when measured with CIE L*A*B* color measuring equipment under exclusion of UV light.

Known pigments useful as the colorant of the invention are, for example, quinacridone pigments such as C.I. Pigment Violet 19, Pigment Red 122, Pigment Red 192, Pigment Red 202, Pigment Red 207, Pigment Red 209, Pigment Red 206, Pigment Orange 48, Pigment Orange 49 or Pigment Violet 42, diketopyrrolopyrrole pigments such as Pigment Red 254, Pigment Red 255, Pigment Red 264, Pigment Red 270, Pigment Red 272, Pigment Red 283, Pigment Orange 71, Pigment Orange 73 or Pigment Orange 81, perylene pigments such as Pigment Red 123, Pigment Red 149, Pigment Red 178, Pigment Red 179, Pigment Red 190, Pigment Red 224, Pigment Violet 29, Pigment Black 31, Pigment Black 32, indanthrone pigments such as Pigment Blue 60 or Pigment Blue 64, anthraquinone pigments such as Pigment Yellow 147, Pigment Red 189, Pigment Red 177 or Pigment Yellow 199, azo pigments such as Pigment Yellow 12, Pigment Yellow 13, Pigment Yellow 14, Pigment Yellow 16, Pigment Yellow 17, Pigment Yellow 55, Pigment Yellow 61, Pigment Yellow 62, Pigment Yellow 63, Pigment Yellow 81, Pigment Yellow 83, Pigment Yellow 87, Pigment Yellow 90, Pigment Yellow 93, Pigment Yellow 94, Pigment Yellow 95, Pigment Yellow 100, Pigment Yellow 104, Pigment Yellow 106, Pigment Yellow 113, Pigment Yellow 114, Pigment Yellow 117, Pigment Yellow 120, Pigment Yellow 121, Pigment Yellow 124, Pigment Yellow 126, Pigment Yellow 127, Pigment Yellow 128, Pigment Yellow 129, Pigment Yellow 133, Pigment Yellow 136, Pigment Yellow 150, Pigment Yellow 151, Pigment Yellow 152, Pigment Yellow 153, Pigment Yellow 154, Pigment Yellow 155, Pigment Yellow 166, Pigment Yellow 168, Pigment Yellow 169, Pigment Yellow 170, Pigment Yellow 171, Pigment Yellow 172, Pigment Yellow 174, Pigment Yellow 175, Pigment Yellow 176, Pigment Yellow 177, Pigment Yellow 179, Pigment Yellow 180, Pigment Yellow 181, Pigment Yellow 183, Pigment Yellow 188, Pigment Yellow 190, Pigment Yellow 191, Pigment Yellow 194, Pigment Orange 13, Pigment Orange 15, Pigment Orange 16, Pigment Orange 17, Pigment Orange 17:1, Pigment Orange 19, Pigment Orange 22, Pigment Orange 24, Pigment Orange 31, Pigment Orange 34, Pigment Orange 36, Pigment Orange 38, Pigment Orange 44, Pigment Orange 46, Pigment Orange 60, Pigment Orange 62, Pigment Orange 65, Pigment Orange 68, Pigment Red 2, Pigment Red 5, Pigment Red 7, Pigment Red 8, Pigment Red 9, Pigment Red 10, Pigment Red 11, Pigment Red 12, Pigment Red 13, Pigment Red 14, Pigment Red 15, Pigment Red 16, Pigment Red 17, Pigment Red 18, Pigment Red 21, Pigment Red 22, Pigment Red 23, Pigment Red 31, Pigment Red 32, Pigment Red 37, Pigment Red 38, Pigment Red 41, Pigment Red 48:1, Pigment Red 48:2, Pigment Red 48:4, Pigment Red 48:5, Pigment Red 49, Pigment Red 49:1, Pigment Red 49:2, Pigment Red 49:3, Pigment Red 50:1, Pigment Red 51, Pigment Red 52:1, Pigment Red 52:2, Pigment Red 53, Pigment Red 53:1, Pigment Red 53:, Pigment Red 57:1, Pigment Red 58:2, Pigment Red 58:4, Pigment Red 60:1, Pigment Red 63:1, Pigment Red 63:2, Pigment Red 64, Pigment Red 64:1, Pigment Red 66, Pigment Red 67, Pigment Red 68, Pigment Red 95, Pigment Red 111, Pigment Red 112, Pigment Red 114, Pigment Red 119, Pigment Red 136, Pigment Red 144, Pigment Green 10, Pigment Red 146, Pigment Red 147, Pigment Red 148, Pigment Red 150, Pigment Red 151, Pigment Red 164, Pigment Red 166, Pigment Red 170, Pigment Red 171, Pigment Red 175, Pigment Red 176, Pigment Red 184, Pigment Red 185, Pigment Red 187, Pigment Red 188, Pigment Red 200, Pigment Red 208, Pigment Red 210, Pigment Red 212, Pigment Red 213, Pigment Red 214, Pigment Red 220, Pigment Red 221, Pigment Red 222, Pigment Red 223, Pigment Red 237, Pigment Red 238, Pigment Red 239, Pigment Red 240, Pigment Red 242, Pigment Red 243, Pigment Red 245, Pigment Red 247, Pigment Red 247:1, Pigment Red 253, Pigment Red 256, Pigment Red 257, Pigment Red 258, Pigment Red 261, Pigment Brown 1, Pigment Brown 5, Pigment Brown 25, Pigment Violet 13, Pigment Brown 23, Pigment Violet 25, Pigment Violet 32, Pigment Violet 44, Pigment Violet 50, Pigment Blue 25 or Pigment Green 8, isoindoline pigments such as Pigment Yellow 109, Pigment Yellow 110, Pigment Yellow 173, Pigment Yellow 139, Pigment Yellow 185, Pigment Orange 61, Pigment Orange 66, Pigment Orange 69 or Pigment Red 260 and phthalocyanine pigments such as Pigment Blue 15, Pigment Blue 15:1, Pigment Blue 15:2, Pigment Blue 15:3, Pigment Blue 15:4, Pigment Blue 15:6, Pigment Blue 16, Pigment Green 7, Pigment Green 36 or Pigment Green 37.

The substrate to which the coating or film is applied can be any desired substrate, for example a metal, wood, paper, plastic, composite, glass or ceramic article in any solid form.

Another embodiment provides a laser marked article comprising the fluorescent form and non-fluorescent form of a colorant as described above, which article contains markings which are indiscernible under ambient visible light but discernable when exposed to specific wavelengths of ultraviolet light, which markings comprise the fluorescent form of the colorant in a higher concentration than the remainder of the article.

In one useful aspect of the invention, the fluorescent markings are formed by exposure to the thermal radiation provided by a laser.

The fluorescent markings of the invention are luminescent, and therefore readily visible when exposed to ultra-violet light, ultra violet being that part of the electromagnetic spectrum with wavelengths between about 200 nm and 400 nm. The markings can be any markings including letters, numbers, bar codes, geometric shapes, other figures including logos and other designs. The markings result from domains of the substrate having a higher amount of the fluorescent form of a colorant than in other domains. The concentration of the fluorescent form of the colorant in the marked domains of the composition or article can vary greatly provided that there is a sufficiently higher amount of the fluorescent form so that the makings are clearly discernable from the remaining portions of the composition or article under the appropriate UV radiation.

The “defined domains” or “marked domains” of the instant composition are the portions of the composition which contain the higher concentration of fluorescent colorant, i.e., fluorescing domains. These correlate to the “specific domains” which are subjected to heat in the instant method. The defined domains containing the fluorescent form of the colorant can be understood as the three dimensional region below and including the area of the surface which is exposed to heat extending in depth as far as the heat necessary to form the fluorescent species penetrates.

The amount of fluorescent form of the colorant within the fluorescing domains of the composition is not readily defined by a specific quantitative weight percentage, but rather by the fluorescing and color effects observed as detailed above. For example, as a laser penetrates a substrate, the amount of radiation impacting lower regions of the substrate can be less than the amount of radiation impacting the surface. Therefore, a gradient of fluorescent form concentration may form under the area which is marked, with the highest concentration of fluorescent species existing where the amount of heat generated by the laser radiation is the highest.

The amount of fluorescent form will depend largely on the amount of heat applied, for example, the time and intensity of laser radiation. However, the fluorescent form may degrade under many environmental conditions, such as light exposure, faster than the non-fluorescent pigment. Also, too high of a concentration of a fluorescing species may alter the appearance of the substrate in ways that are evident under lighting conditions that contain only a small amount of UV light, e.g. sunlight, or it may even lead to decrease in fluorescence due for example to vibrational quenching. Excessive alteration of the colorant's physical environment may also cause a visible color shift of the marked areas.

It is advisable therefore to choose the heat exposure conditions with care so that enough fluorescent species is created within the exposed domain for clear UV detection, while keeping other undesirable changes to the substrate to a minimum. This can be accomplished by the most routine experimentation.

Naturally, the fluorescence will only occur when the fluorescing colorant is exposed to those wavelengths of ultraviolet which are absorbed by the colorant. Also, the color of the fluorescence will depend on the wavelengths of the light that are emitted from the colorant during fluorescence. Different colorants, even colorants that are the same color under ambient light, can therefore be used to generate markings with different colored fluorescence, or that fluoresce when exposed to different portions of the UV spectrum.

As stated, the fluorescent markings are not readily apparent under ambient light. “Ambient light”, “ambient visible light” or “ambient lighting conditions” are the conditions encountered in typical outdoor or indoor lighting, for example, dominated by that part of the electromagnetic spectrum with wavelengths between about 400 and 800 nm, although some ultra violet light with wavelengths below 400 nm and IR radiation above 800 nm is frequently present.

“Not readily apparent under ambient light”, “not discernable under ambient light” or “not readily discernable under ambient light” means that there is no visible difference in color under normal outdoor or indoor lighting conditions of the laser marked portion of the substrate and that any visibly discernable change in the appearance of the substrate as a result of laser marking, for example, a change in gloss or color, is absent or perceptible only under rigorous examination or exposure to UV light. Normally, a colour difference ΔE* of ≦3, preferably ≦2 (CIE L*A*B* colour space), is not recognized by the large majority of humans.

For example, when a red coating containing a red quinacridone pigment, such as Pigment Red 202, is marked with a laser, the markings are not visible under ambient light, i.e. the entire coating remains red, however, the markings fluoresce a yellow color under a black light source (i.e., an ultra violet light source).

Likewise, when a red coating containing a red DPP pigment, such as Pigment Red 283, is marked with a laser, the markings are not visible under ambient light, i.e. the entire coating remains red, however, now the markings fluoresce a more green colored yellow under a black light source (i.e., an ultra violet light source).

Hence, the no marking is visible under ambient viewing conditions, but patterns of selected colors are readily apparent when viewed under the appropriate ultra violet radiation. This is a useful feature, for example, in security marking applications.

It is of course understood that a certain finite amount of dissolved pigment or fluorescing species derived from the pigment may be present throughout the pigmented substrate which is subjected to, for example, the laser marking of this invention. It is unrealistic to assume that the pigment is a pristine single species without contaminate or that absolutely none of the pigment is dissolved or otherwise converted into a fluorescing species during processing. The marked substrates of this invention are characterized in that the concentration of the fluorescing form of the colorant derived from the selected pigment is higher in the fluorescing domains than in the rest of the substrate.

In the practice of the invention, it is desirable that the pigment should remain insoluble throughout the processing of the pigmented polymeric substrate to avoid unwanted fluorescence throughout the entire article. This allows for greater contrast between the laser marked and unmarked portions when exposed to ultra-violet light.

A particular embodiment of the invention pertains to pigmented coatings which as a result of laser marking as have fluorescent markings. Coatings can be applied to many substrates and generally the temperatures encountered in applying and curing the coating are not high enough to dissolve the pigment particle or cause undue degradation of the pigment.

Another embodiment of the invention pertains to other pigmented polymeric substrates, such as films and molded articles, which bear fluorescent markings as a result of laser marking.

The colorants are present in the laser markable composition in an “effective amount”, that is an amount that provides both the desired level of pigmentation or coloration of the composition and which also lends itself to heat induced marking, e.g., laser marking, under acceptable irradiation conditions. For example, prior to laser marking, the selected quinacridone, DPP or perylene pigment is present in an amount of as little as 0.01 to 15% weight percent based on the total weight of the composition, for example 0.1 to 10% based on the total weight of the composition, but can be present in much higher amounts, for example as high as 50% to 99% especially when used as part of a coating composition or impregnated into the surface of an article.

Accordingly, the amount of colorant including non-fluorescent and fluorescent forms in a composition may be from 0.01 to 99% by weight, based on the total weight of the composition; the amount of polymer in a composition may be from 1 to 99.99% by weight, based on the total weight of the composition. The composition may also comprise further components, such as described below, in amounts, for example, from 0.001 to 90% by weight of further components, based on the total weight of the composition.

Typically a coating comprises before heat induced marking, 0.01-50% by weight of the pigment based on the total weight of the solid binder, for example, 0.1-30%, or 0.1-10% by weight based on the total weight of the solid binder.

The polymer composition bearing fluorescent laser markings of the present invention comprises a synthetic or naturally occurring polymer. For example, the naturally occurring or synthetic polymer may be a thermoplastic, thermoset, crosslinked or inherently crosslinked polymer, for example, a polyolefin, polyamide, polyurethane, polyacrylate, polyacrylamide, polyvinyl alcohol, polycarbonate, polystyrene, polyester, polyacetal, a natural or synthetic rubber or a halogenated vinyl polymer such as PVC. The polymer may be a co-polymer, a polymer blend or part of a composite.

The polymer composition may also optionally have incorporated therein other additives such as antioxidants, UV absorbers, hindered amine or other light stabilizers, phosphites or phosphonites, benzofuran-2-ones, thiosynergists, polyamide stabilizers, metal stearates, nucleating agents, fillers, reinforcing agents, lubricants, emulsifiers, dyes, pigments, dispersants, optical brighteners, flame retardants, antistatic agents, blowing agents and the like, other processing agents or mixtures thereof.

Examples of thermoplastic, thermoset, elastomeric, inherently crosslinked or crosslinked polymers into which the colorants of the present invention may be incorporated into include polyolefins, polyamides, polyurethanes, polyacrylates, polyacrylamides, polycarbonates, polystyrenes, polyvinyl acetates, polyvinyl alcohols, polyesters, halogenated vinyl polymers such as PVC, alkyd resins, epoxy resins, unsaturated polyesters, unsaturated polyamides, polyimides, fluorinated polymers, silicon containing polymers, carbamate polymers and copolymers thereof such as those listed below.

1. Polymers of mono- and di-olefins, for example polypropylene, polyisobutylene, polybutene-1, poly-4-methylpentene-1, polyisoprene or polybutadiene and also polymerisates of cyclo-olefins, for example of cyclopentene or norbornene; and also polyethylene (which may optionally be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE).

Polyolefins, that is to say polymers of mono-olefins, as mentioned by way of example in the preceding paragraph, especially polyethylene and polypropylene, can be prepared by various processes, especially by the following methods:

a) by free radical polymerisation (usually at high pressure and high temperature);
b) by means of a catalyst, the catalyst usually containing one or more metals of group IVb, Vb, VIb or VIII. Those metals generally have one or more ligands, such as oxides, halides, alcoholates, esters, ethers, amines, alkyls, alkenyls and/or aryls, which may be either π- or σ-coordinated. Such metal complexes may be free or fixed to carriers, for example to activated magnesium chloride, titanium(III) chloride, aluminium oxide or silicon oxide. Such catalysts may be soluble or insoluble in the polymerisation medium. The catalysts can be active as such in the polymerisation or further activators may be used, for example metal alkyls, metal hydrides, metal alkyl halides, metal alkyl oxides or metal alkyl oxanes, the metals being elements of group(s) Ia, IIa and/or IIIa. The activators may have been modified, for example, with further ester, ether, amine or silyl ether groups.

2. Mixtures of the polymers mentioned under 1), for example mixtures of poly-propylene with polyisobutylene, polypropylene with polyethylene (for example PP/HDPE, PP/LDPE) and mixtures of different types of polyethylene (for example LDPE/HDPE).

3. Copolymers of mono- and di-olefins with one another or with other vinyl monomers, for example ethylene/propylene copolymers, linear low density polyethylene (LLDPE) and mixtures thereof with low density polyethylene (LDPE), propylene/butene-1 copolymers, propylene/isobutylene copolymers, ethylene/butene-1 copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and copolymers thereof with carbon monoxide, or ethylene/acrylic acid copolymers and salts thereof (ionomers), and also terpolymers of ethylene with propylene and a diene, such as hexadiene, dicyclopentadiene or ethylidenenorbornene; and also mixtures of such copolymers with one another or with polymers mentioned under 1), for example polypropylene-ethylene/propylene copolymers, LDPE-ethylene/vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides.

4. Hydrocarbon resins (for example C₅-C₉) including hydrogenated modifications thereof (for example tackifier resins) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylo-nitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/styrene.

7. Graft copolymers of styrene or α-methylstyrene, for example styrene on poly-butadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned under 6), such as those known, for example, as so-called ABS, MBS, ASA or AES polymers.

8. Halogen-containing polymers, for example polychloroprene, chlorinated rubber, chlorinated and brominated copolymer of isobutylene/isoprene (halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate.

9. Polymers derived from α,β-unsaturated acids and derivatives thereof, such as polyacrylates and polymethacrylates, or polymethyl methacrylates, polyacrylamides and polyacrylonitriles impact-resistant-modified with butyl acrylate.

10. Copolymers of the monomers mentioned under 9) with one another or with other unsaturated monomers, for example acrylonitrile/butadiene copolymers, acrylo-nitrile/alkyl acrylate copolymers, acrylonitrile/alkoxyalkyl acrylate copolymers, acrylonitrile/vinyl halide copolymers or acrylonitrile/alkyl methacrylate/butadiene terpolymers.

11. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1.

12. Homo- and co-polymers of cyclic ethers, such as polyalkylene glycols, poly-ethylene oxide, polypropylene oxide or copolymers thereof with bisglycidyl ethers.

13. Polyacetals, such as polyoxymethylene, and also those polyoxymethylenes which contain comonomers, for example ethylene oxide; polyacetals modified with thermoplastic polyurethanes, acrylates or MBS.

14. Polyphenylene oxides and sulfides and mixtures thereof with styrene polymers or polyamides.

15. Polyurethanes derived from polyethers, polyesters and polybutadienes having terminal hydroxyl groups on the one hand and aliphatic or aromatic polyisocyanates on the other hand, and their initial products.

16. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamides prepared from hexamethylenediamine and iso- and/or tere-phthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or ABS; and polyamides condensed during processing (“RIM polyamide systems”).

17. Polyureas, polyimides, polyamide imides, polyether imides, polyester imides, polyhydantoins and polybenzimidazoles.

18. Polyesters derived from dicarboxylic acids and dialcohols and/or from hydroxy-carboxylic acids or the corresponding lactones, such as polyethylene terephthalate, polybutylene terephthalate, poly-1,4-dimethylolcyclohexane terephthalate, polyhydroxy-benzoates, and also block polyether esters derived from polyethers with hydroxyl terminal groups; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, urea or melamine on the other hand, such as phenol-formaldehyde, urea-formaldehyde and melamine-formaldehyde resins.

22. Drying and non-drying alkyd resins.

23. Unsaturated polyester resins derived from copolyesters of saturated and unsaturated dicarboxylic acids with polyhydric alcohols, and also vinyl compounds as crosslinking agents, and also the halogen-containing, difficulty combustible modifications thereof.

24. Crosslinkable acrylic resins derived from substituted acrylic esters, e.g. from epoxy acrylates, urethane acrylates or polyester acrylates.

25. Alkyd resins, polyester resins and acrylate resins that are crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, e.g. products of bisphenol-A diglycidyl ethers, bisphenol-F diglycidyl ethers, that are crosslinked using customary hardeners, e.g. anhydrides or amines with or without accelerators.

27. Natural polymers, such as cellulose, natural rubber, gelatin, or polymer-homologously chemically modified derivatives thereof, such as cellulose acetates, propionates and butyrates, and the cellulose ethers, such as methyl cellulose; and also colophonium resins and derivatives.

28. Mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermo-plastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The polymer composition containing the fluorescent markings may be a coating which has been applied to a substrate. The coating can comprise any coating system which both adheres to the substrate and is compatible with the selected pigment, for example, auto coatings, marine coatings, paints, inks, laminates, receiving layers for printing applications, or other protective or decorative coatings including fabric treatments and coatings or films used in glazing applications. A coating or film in which the selected pigment is overly soluble will cause the system to fluoresce without heat exposure and is not appropriate for this aspect of the invention.

The coating composition according to the invention can be applied to any desired substrate, for example to metal, wood, plastic, composite, glass or ceramic material substrates by the customary methods, for example by brushing, spraying, pouring, draw down, spin coating, dipping or electrophoresis; see also Ullmann's Encyclopedia of Industrial Chemistry, 5th Edition, Vol. A18, pp. 491-500.

Typically, the coating comprises a polymeric binder which can in principle be any binder customary in industry, for example those described in Ullmann's Encyclopedia of Industrial Chemistry, 5th Edition, Vol. A18, pp. 368-426, VCH, Weinheim 1991. In general, it is a film-forming binder based on a thermoplastic or thermosetting resin, predominantly on a thermosetting resin. Examples thereof are alkyd, acrylic, acrylamide, polyester, styrenic, phenolic, melamine, epoxy and polyurethane resins.

For example, non-limiting examples of common coating binders useful in the present invention include silicon containing polymers, fluorinated polymers, unsaturated polyesters, unsaturated polyamides, polyimides, crosslinkable acrylic resins derived from substituted acrylic esters, e.g. from epoxy acrylates, urethane acrylates, polyester acrylates, polymers of vinyl acetate, vinyl alcohol and vinyl amine. The coating binder polymers may be co-polymers, polymer blends or composites.

Coatings are frequently crosslinked with, for example, melamine resins, urea resins, isocyanates, isocyanurates, polyisocyanates, epoxy resins, anhydrides, poly acids and amines, with or without accelerators.

The binder can be a cold-curable or hot-curable binder provided that the temperature is not high enough to cause dissolution of the pigment from which the fluorescent markings are produced; the addition of a curing catalyst may be advantageous. Suitable catalysts which accelerate curing of the binder are described, for example, in Ullmann's Encyclopedia of Industrial Chemistry, Vol. A18, p. 469, VCH Verlagsgesellschaft, Weinheim 1991.

The binder may be a surface coating resin which dries in the air or hardens at room temperature. Exemplary of such binders are nitrocellulose, polyvinyl acetate, polyvinyl chloride, unsaturated polyester resins, polyacrylates, polyurethanes, epoxy resins, phenolic resins, and especially alkyd resins. The binder may also be a mixture of different surface coating resins. Provided the binders are curable binders, they are normally used together with a hardener and/or accelerator.

Examples of coating compositions containing specific binders are:

1. coatings based on cold- or hot-crosslinkable alkyd, acrylate, polyester, epoxy or melamine resins or mixtures of such resins, if desired with addition of a curing catalyst;

2. two-component polyurethane coatings based on hydroxyl-containing acrylate, polyester or polyether resins and aliphatic or aromatic isocyanates, isocyanurates or polyisocyanates;

3. one-component polyurethane coatings based on blocked isocyanates, isocyanurates or polyisocyanates which are deblocked during baking, if desired with addition of a melamine resin;

4. one-component polyurethane coatings based on a Trisalkoxycarbonyltriazine crosslinker and a hydroxyl group containing resin such as acrylate, polyester or polyether resins;

5. one-component polyurethane coatings based on aliphatic or aromatic urethaneacrylates or polyurethaneacrylates having free amino groups within the urethane structure and melamine resins or polyether resins, if necessary with curing catalyst;

6. two-component coatings based on (poly)ketimines and aliphatic or aromatic isocyanates, isocyanurates or polyisocyanates;

7. two-component coatings based on (poly)ketimines and an unsaturated acrylate resin or a polyacetoacetate resin or a methacrylamidoglycolate methyl ester;

8. two-component coatings based on carboxyl- or amino-containing polyacrylates and polyepoxides;

9. two-component coatings based on acrylate resins containing anhydride groups and on a polyhydroxy or polyamino component;

10. two-component coatings based on acrylate-containing anhydrides and polyepoxides;

11. two-component coatings based on (poly)oxazolines and acrylate resins containing anhydride groups, or unsaturated acrylate resins, or aliphatic or aromatic isocyanates, isocyanurates or polyisocyanates;

12. two-component coatings based on unsaturated polyacrylates and polymalonates;

13. thermoplastic polyacrylate coatings based on thermoplastic acrylate resins or externally crosslinking acrylate resins in combination with etherified melamine resins;

14. paint systems based on siloxane-modified or fluorine-modified acrylate resins.

Acrylic, methacrylic and acrylamide polymers and co-polymers dispersible in water are readily used as a binder in the present invention. For example, acrylic, methacrylic and acrylamide dispersion polymers and co-polymers.

The coating composition can also comprise further components, examples being solvents, pigments, dyes, plasticizers, stabilizers, thixotropic agents, drying catalysts and/or levelling agents. Examples of possible components are those described in Ullmann's Encyclopedia of Industrial Chemistry, 5th Edition, Vol. A18, pp. 429-471, VCH, Weinheim 1991.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds such as organotin compounds, for example.

Examples of metal carboxylates are the stearates of Pb, Mn or Zn, the octoates of Co, Zn or Cu, the naphthenates of Mn and Co or the corresponding linoleates, resinates or tallates.

Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate, and the alkoxides of these metals.

Examples of organotin compounds are dibutyltin oxide, dibutyltin dilaurate or dibutyltin dioctoate.

Examples of amines are, in particular, tertiary amines, for example tributylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzyl-ammonium chloride.

Amino-containing resins are simultaneously binder and curing catalyst. Examples thereof are amino-containing acrylate copolymers.

The curing catalyst used can also be a phosphine, for example triphenylphosphine.

The coating compositions can also be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451-453. In radiation-curable coating compositions, the novel stabilizers can also be employed without the addition of sterically hindered amines.

The coating may also be a radiation-curable, solvent-free formulation of photopolymerisable compounds. Illustrative examples are mixtures of acrylates or methacrylates, unsaturated polyester/styrene mixtures or mixtures of other ethylenically unsaturated monomers or oligomers.

The coating compositions can comprise an organic solvent or solvent mixture in which the binder is soluble. The coating composition can otherwise be an aqueous solution or dispersion. The vehicle can also be a mixture of organic solvent and water. The coating composition may be a high-solids paint or can be solvent-free (e.g. a powder coating material). Powder coatings are, for example, those described in Ullmann's Encyclopedia of Industrial Chemistry, 5th Ed., A18, pages 438-444. The powder coating material may also have the form of a powder-slurry (dispersion of the powder preferably in water).

Multilayer systems are possible, where the pigments of the invention reside in a coating (or substrate) which is then coated with another coating, such as a protective coating.

When used in a coating the pigments, for example the quinacridone, DPP or perylene pigments are incorporated into the coating via techniques common in the art.

The compounds may be added as an individual component during blending, for example, dry blending of the resin prior to prior to processing, or the compound may be added as a blend, master batch, flush, or other concentrate in or with another substance prior to processing.

The compounds may be added during processing steps. Standard process steps for polymer resins and coating formulations are well known in the art and include extrusion, coextrusion, compression molding, Brabender melt processing, film formation, injection molding, blow molding, other molding and sheet forming processes, fiber formation, surface impregnation, dissolution, suspension, dispersion and other methods known in plastic and coatings technology.

When composition of the invention is a film, the film may be a stand alone film or may be applied to the surface of a substrate by, for example, the use of an adhesive, or co-extruded onto the surface. A film can be prepared for example, from the resin melt, by casting from a solution or by another method known in the art. A preformed film may also be applied with heat which includes calendaring, melt applications and shrink wrapping.

When the heat source used to form the fluorescent species is a laser, it may be any laser that delivers radiation at wavelengths that are absorbed by the polymer composition in a manner which discreetly heats the selected portion of the substrate to leave the desired marking.

For Example, lasers used to produce markings visible under ambient lighting are useful in the present invention. See for example U.S. Pat. Nos. 4,861,620; 6,022,905; 5,075,195; co pending U.S. Application No. 60/738,455 already incorporated by reference, as well as European patent applications 0 036 680 and 0 190 997, and U.S. Pat. No. 4,307,047, which US patent is hereby incorporated by reference.

The marking can be any marking including letters, numbers, bar codes, geometric shapes and other figures including logos and other designs.

For Example, lasers used to produce markings visible under ambient lighting are useful in the present invention. As one example of a useful laser, color marks have been formed on a dark background by a Nd:YAG laser or a frequency doubled Nd:YAG laser (wavelength 532 nm), employing a polyacetal copolymer resin or a polybutylene terephthalate resin combined with a mineral black pigment (bone charcoal, bone black or ivory black) that is removed or destroyed by the laser, and a heat-stable organic and/or inorganic pigment or a polymer-soluble dye. Color marks have also been achieved with a Nd:YAG laser on thermoplastics that have been colored by an organic dye or pigment and an inorganic pigment of the same color, and which also contain carbon black. These color marks have the same color as the background color of the plastic, but have a lighter tone.

Methods for producing laser marks by dye bleaching of dye compositions are known in the art as described above and are readily modified to suit the present needs. See also the discussion in U.S. Pat. No. 6,022,905.

Such lasers are readily adaptable to the present invention. Other lasers useful in the invention are known and many are commercially available.

Methods for deflecting the laser beam through a mask or otherwise directed over the surface of the object to be marked, in conformity with the shape of the marking which is to be applied are likewise known.

More than one pigment can be used in any composition or method herein. Other types of pigments and colorants such as dyes may also be present.

It is worthy of note that in addition to the colorant that undergoes conversion to the fluorescent form during the practice of this invention, colorants which do not undergo such a change may also be present. Also, more than one colorant that undergoes conversion to the fluorescent form during the practice of this invention may be present. The composition may also include a laser energy-absorbing additive, such as carbon black, graphite, kaolin, mica, and the like, that increases the rate of temperature rise in the localized portion of the polymer exposed to the laser. Laser energy absorbing additives are also known to causing dye bleaching or other dye transformation by energy transfer mechanisms to the dye directly.

In one embodiment of the present invention laser energy absorbing additives are present in the markable composition; in another embodiment of the invention laser energy absorbing additives are not present in the markable composition.

### EXAMPLES

### Example 1

A mixture of a toner containing Pigment Red 202 (a quinacridone pigment), DISPERBYK 161, an acrylic mill base and a letdown is milled with 2 mm glass beads using a SKANDEX mill. The resulting paint is separated from the beads.

A drawdown of the paint using a 100 micron wet film wired bar and a KCC automatic film applicator is prepared and dried over a leneta card and laser marked. The red coating appears unchanged under ambient visible light, but under black light (UV light) the mark fluoresces bright yellow.

### Example 2

The procedure of Example 1 is repeated using a toner prepared with Pigment Red 283 (a DPP pigment), to provide a red coating which is laser marked. The red coating appears unchanged under ambient visible light, but under black light (UV light) the mark fluoresces a green shade of yellow.

### Example 3

A mixture of toner containing Pigment Red 283, POLANE G, (Polyurethane coating from The SHERWIN-WILLIAMS COMPANY) and 100 g of 2 mm glass beads is shaken for 2 hours using a SKANDEX mill. The resulting mill base is separated from the beads.

To the resulting mill base is added one third by weight of catalyst isocyanate followed by mixing. This paint is drawdown with a 3 mil bar over a leneta card. The coating is allowed to cure at room temperature overnight and is laser marked. The red coating appears unchanged under ambient visible light, but under black light (UV light) the mark fluoresces yellow.

### Example 4

The procedure of Example 3 is repeated using a toner prepared with MAGENTA PIGMENT RT 343 (a quinacridone pigment), to provide a red coating which is laser marked. The red coating appears unchanged under ambient visible light, but fluoresces strongly under black light.

What is claimed:

1. A composition comprising a natural or synthetic polymer and a colorant, which colorant is present throughout the composition and which colorant is present in a fluorescent form and a non-fluorescent form, wherein
the non-fluorescent form of the colorant is a pigment selected from the group consisting of quinacridone, diketopyrrolopyrrole (DPP), perylene, indanthrone, anthroquinone, azo, isoindoline and phthalocyanine pigments and mixed crystals and solid solutions thereof, and
the fluorescent form of the colorant is of the same chemical formula as the pigment and is obtained from the pigment by exposure of specific portions of the composition to heat to form defined domains,
wherein the defined domain is a three dimensional region below and including the area of the surface which is exposed to heat extending in depth as far as the heat necessary to form the fluorescent species penetrates
wherein the fluorescent form of the pigment is present at a higher concentration in the defined domains relative to the remainder of the composition to display an identifiable fluorescent marking when exposed to appropriate wavelengths of ultraviolet light
and wherein the defined domains containing a higher concentration of the fluorescent form of the colorant are of the same color as those parts of the composition which are not exposed to heat when viewed under a light source with a wavelength of from 400 to 700 nm or when measured with CIE L*A*B* color measuring equipment under exclusion of UV light.

2. A composition according to claim 1, wherein the non-fluorescent form of the colorant is a pigment selected from the group consisting of quinacridone, diketopyrrolopyrrole and perylene pigments and mixed crystals and solid solutions thereof, and the fluorescent form of the colorant is of the same chemical formula as the pigment and is obtained from the pigment by exposure to heat.

3. A composition according to claim 1, wherein the natural or synthetic polymer is a thermoplastic, thermoset, crosslinked or inherently crosslinked polymer.

4. A composition according to claim 3, wherein the thermoplastic, thermoset, crosslinked or inherently crosslinked polymer is selected from polymers of the group polyolefins, polyamides, polyurethanes, polyacrylates, polyacrylamides, polycarbonates, polystyrenes, polyvinyl acetates, polyvinyl alcohols, polyester, halogenated vinyl polymers, alkyd resins, epoxy resins, unsaturated polyesters, unsaturated polyamides, polyimides, fluorinated polymers, silicon containing polymers, carbamate polymers and copolymers thereof.

5. A composition according to claim 1, wherein the polymer composition is a coating or film.

6. A method for producing a polymer composition bearing fluorescent markings, which method comprises incorporating into a natural or synthetic polymer a non-fluorescent form of a colorant selected from quinacridone, diketopyrrolopyrrole, perylene indanthrone, anthroquinone, azo, isoindoline and phthalocyanine pigments and mixed crystals and solid solutions thereof, and then exposing specific domains of the polymer composition to heat to convert portions of the pigment into a fluorescent form of the colorant producing markings which fluoresce when exposed to appropriate wavelengths of ultra violet light wherein the specific domains which are exposed to heat to produce the fluorescent markings remain the same color as those parts of the composition which are not exposed to heat when viewed under a light source with a wavelength of from 400 to 700 nm or when measured with CIE L*A*B* color measuring equipment under exclusion of UV light.

7. A method for producing a polymer composition bearing fluorescent markings according to claim 6, wherein the non-fluorescent form of a colorant incorporated into a natural or synthetic polymer is selected from quinacridone, diketopyrrolopyrrole and perylene pigments and mixed crystals and solid solutions thereof.

8. A method for producing a polymer composition bearing fluorescent markings according to claim 6, wherein the markings are formed by exposure to laser irradiation.

9. A method for producing a polymer composition bearing fluorescent markings according to claim 6, wherein the natural or synthetic polymer is a thermoplastic, thermoset, crosslinked or inherently crosslinked polymer.

10. A method for producing a polymer composition bearing fluorescent markings according to claim 6, wherein the thermoplastic, thermoset, crosslinked or inherently crosslinked polymer is selected from polymers of the group, polyolefins, polyamides, polyurethanes, polyacrylates, polyacrylamides, polycarbonates, polystyrenes, polyvinyl acetates, polyvinyl alcohols, polyesters, halogenated vinyl polymers, alkyd resins, epoxy resins, unsaturated polyesters, unsaturated polyamides, polyimides, fluorinated polymers, silicon containing polymers, carbamate polymers and copolymers thereof.

11. A method for producing a polymer composition bearing fluorescent markings according to claim 6, wherein the polymer composition is a coating or film.

12. A method for producing a laser marked substrate, which method comprises applying to a substrate a coating or film comprising a polymer and a non-fluorescent form of a colorant selected from quinacridone, diketopyrrolopyrrole, perylene, indanthrone, anthraquinone, azo, isoindoline and phthalocyanine pigments, mixed crystals and solid solutions thereof, then exposing specific domains of the coating or film to heat, to convert portions of the pigment into a fluorescent form of the colorant producing markings which fluoresce when exposed to appropriate wavelengths of ultra violet light, wherein the specific domains which are exposed to heat to produce the fluorescent markings remain the same color as those parts of the composition which are not exposed to heat when viewed under a light source with a wavelength of from 400 to 700 nm or when measured with CIE L*A*B* color measuring equipment under exclusion of UV light.

13. A laser marked article comprising a composition according to claim 1.

14. A laser marked article comprising a substrate and a coating wherein the coating comprises a composition according to claim 1.
